(19) United States
(12) Patent Application Publication
(10) Pub. No.: US 2016/0180237 A1
(43) Pub. Date: Jun. 23, 2016

(54) MANAGING A QUESTION AND ANSWER SYSTEM

(71) Applicant: International Business Machines Corporation, Armonk, NY (US)

(72) Inventors: Salil Ahuja, Austin, TX (US); Scott H. Isensee, Austin, TX (US); Robert C. Johnson, JR., Pescadero, CA (US); Scott M. Lewis, Toronto (CA); William G. O'Keeffe, Tewksbury, MA (US); Cale R. Vardy, East York (CA)

(21) Appl. No.: 14/864,285

(22) Filed: Sep. 24, 2015

Related U.S. Application Data
(63) Continuation of application No. 14/573,555, filed on Dec. 17, 2014.

(51) Int. Cl. G06N 5/04; G06N 5/02

(52) U.S. Cl. CPC G06N 5/048; G06N 5/022

(57) ABSTRACT

Disclosed aspects include managing data for a Question and Answering (QA) system. Aspects include a set of questions being received by the QA system. In response to receiving the set of questions, a first confidence score for a first answer to a first question of the set of questions is determined. Aspects include determining the first confidence score meets a threshold confidence score. In response to the first confidence score meeting the threshold confidence score, the QA system stores the first question and the first answer for future presentation use as an aid in formulating a second query.

### BACKGROUND

This disclosure relates generally to computer systems and, more particularly, relates to a question and answer system. With the increased usage of computing networks, such as the Internet, humans can be inundated and overwhelmed with the amount of information available to them from various structured and unstructured sources. However, information gaps can occur as users try to piece together relevant material during searches for information on various subjects. To assist with such searches, recent research has been directed to generating Question and Answer (QA) systems which may take an input question, analyze it, and return results to the input question. QA systems provide mechanisms for searching through large sets of sources of content (e.g., electronic documents) and analyze them with regard to an input question to determine an answer to the question.

### SUMMARY

Aspects of the disclosure include managing data for a Question and Answering (QA) system. Aspects include a set of questions being received by the QA system. In response to receiving the set of questions, a first confidence score for a first answer to a first question of the set of questions is determined. Aspects include determining the first confidence score meets a threshold confidence score. In response to the first confidence score meeting the threshold confidence score, the QA system stores the first question and the first answer for future presentation use as an aid in formulating a second query.

In embodiments, a second question is received. It may be determined that the second question is related to the first question. Subsequently, an output can be selected for presentation. The output can include the first question, the first answer, the first confidence score, a group of questions, a group of answers, a group of confidence scores, a first past-user rating, an answer-evaluation value, or a first-user identifier. An entry-expectation feature may be used to receive the second question from the user and to present to the user the output including the answer-evaluation value.

Aspects of the disclosure include establishing first and second past-user ratings. The first past-user rating can be associated with the first question, the first answer, and the first confidence score. The second past-user rating can be associated with the second question, the second answer, and the second confidence score. A third question may be received (e.g., received from a user). In response to receiving the third question, it can be determined that the third question is related to both the first question and the second question. In response to determining the third question is related to both the first question and the second question, an output may be determined. Determining the output can use the first and second past-user ratings.

### BRIEF DESCRIPTION OF THE DRAWINGS

FIG. 1 is a diagrammatic illustration of an exemplary computing environment, consistent with embodiments of the present disclosure.

FIG. 2 is a system diagram depicting a high level logical architecture for a question answering system, consistent with embodiments of the present disclosure.

FIG. 3 is a block diagram illustrating a question answering system to generate answers to one or more input questions, consistent with various embodiments of the present disclosure.

FIG. 4 is a flowchart illustrating a method of managing data for a question and answering system according to embodiments.

FIG. 5 is a flowchart illustrating a method of managing data for a question and answering system according to embodiments.

FIG. 6 is a flowchart illustrating a method of managing data for a question and answering system according to embodiments.

FIG. 7 is a flowchart illustrating a method of using stored data by a question and answering system according to embodiments.

FIG. 8 is a flowchart illustrating a method of using stored data by a question and answering system according to embodiments.

FIG. 9 is a flowchart illustrating a method of using stored data by a question and answering system according to embodiments.

FIG. 10 is an illustration of a display of an exemplary computer using a question and answering system according to embodiments.

### DETAILED DESCRIPTION

Aspects of the disclosure include a methodology for displaying previously asked questions to a user of a Question and Answering (QA) system (e.g., Watson™). The QA system may be asked the same questions repeatedly. Based on the way the question is asked, at times the QA system can provide vastly different answers/results. For example, Watson™ may answer a question phrased one way (or with incomplete information) less accurately, but questions phrased in other ways more accurately. Aspects of the disclosure include operations to guide users of the QA system to a more complete question for which the QA system can provide more efficient answers (e.g., better questions can yield better answers).

A list of questions asked of the QA system may be stored. In association with the list, confidence of answers provided by the QA system can be stored. Ratings/scorings/evaluations of the answers, as provided by users of the system, may be accounted for. In collaboration with such various elements, the QA system can generate a list of questions for which the QA system has quality answers. When a particular user starts to type a question into an input text field of a user interface, the particular user can be presented with a type-ahead of possible questions. A more complete question may reduce system load (e.g., fewer follow-up questions), provide a faster response, and learn a question style that returns highly confident results. As such, aspects of the disclosure can produce both result-oriented and performance-oriented efficiencies.

Aspects of the disclosure include a method, a system, an apparatus, and a computer program product of managing data for a Question and Answering (QA) system. Aspects include a set of questions being received by the QA system. In response to receiving the set of questions, a first confidence score for a first answer to a first question of the set of questions is determined. Aspects include determining the first confidence score meets a threshold confidence score. In response to the first confidence score meeting the threshold confidence score, the QA system stores the first question and the first answer for future presentation use as an aid in formulating a second query.

In embodiments, a second question is received (e.g., received from a user). It may be determined that the second question is related to the first question. Subsequently, an output can be selected for presentation (e.g., displayed to the user). To illustrate, the output can include the first question, the first answer, the first confidence score, a group of questions, a group of answers, a group of confidence scores, a first past-user rating, an answer-evaluation value, or a past-user identifier. An entry-expectation feature (e.g., type-ahead feature) may be used to receive the second question from the user and to present to the user the output including the answer-evaluation value.

Aspects of the disclosure include establishing a first past-user rating. The first past-user rating can be associated with the first question, the first answer, and the first confidence score. In response to receiving the set of questions, a second confidence score for a second answer to a second question of the set of questions may be determined. In response to determining the second confidence score meets the threshold confidence score, the QA system may store the second question and the second answer. A second past-user rating may be established. The second past-user rating can be associated with the second question, the second answer, and the second confidence score. A third question may be received (e.g., received from a user). In response to receiving the third question, it can be determined that the third question is related to both the first question and the second question. In response to determining the third question is related to both the first question and the second question, an output may be determined. Determining the output can use the first and second past-user ratings.

In embodiments, the first question is presented to the user in response to the first past-user rating exceeding the second past-user rating. In embodiments when the first past-user rating is substantially equivalent to the second past-user rating, the second question is presented to the user in response to the second confidence score exceeding the first confidence score. In various embodiments, the first past-user rating can be presented in response to a first past-user identifier of the first past-user rating differing from a second past-user identifier of the second past-user rating. In such various embodiments, a current-user identifier for the user may be determined using a natural language processing technique of the QA system. As such, the current-user identifier may match the first user identifier.

Aspects of the disclosure include a method, a system, an apparatus, and a computer program product of using stored data by a Question and Answering (QA) system. A first answer to a first question of a set of questions may be determined. First data configured to be semantically-correlated to the first question and to the first answer can be stored. A central idea for at least a portion of a second question of the set of questions may be determined. Utilizing the central idea, it can be determined that at least the portion of the second question is semantically-correlated to a candidate portion of the first data. The candidate portion may be selected. Aspects of the disclosure may have a positive impact on search results, storage of questions/answers, organization of questions/answers, output of the QA system, or various performance efficiencies. For instance, aspects may be utilized as a learning tool to show users how to construct good questions (e.g., a range of questions from good to bad—together with their ratings—to show what type of information should be included in a question to Watson™).

One example of a QA system which may be used in conjunction with the principles described herein is described in U.S. Patent Application Publication No. 2011/0125734, which is herein incorporated by reference in its entirety. The QA system is configured with one or more a QA system pipelines that receive inputs from various sources. Each QA system pipeline has a plurality of stages for processing an input question, the corpus of data, and generating answers for the input question based on the processing of the corpus of data. For example, the QA system may receive input from a network, a corpus of electronic documents, QA system users, or other data and other possible sources of input. In one embodiment, the content creator creates content in a document of the corpus of data for use as part of a corpus of data with the QA system. QA system users may access the QA system via a network connection or an Internet connection to the network, and may input questions to the QA system that may be answered by the content in the corpus of data. The questions are typically formed using natural language. The QA system interprets the question and provides a response to the QA system user containing one or more answers to the question, e.g., in a ranked list of candidate answers.

The QA system may be the Watson™ QA system available from International Business Machines Corporation of Armonk, N.Y., which is augmented with the mechanisms of the disclosure described hereafter. The Watson™ QA system parses an input question to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the Watson™ QA system. The statistical model may then be used to summarize a level of confidence that the Watson™ QA system has regarding the evidence that the potential response, i.e. candidate answer, is inferred by the question. This process may be repeated for each of the candidate answers until the Watson™ QA system identifies candidate answers that surface as being significantly stronger than others and thus, generates a final answer, or ranked set of answers, for the input question. More information about the Watson™ QA system may be obtained, for example, from the IBM Corporation website, IBM Redbooks, and the like. For example, information about the Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

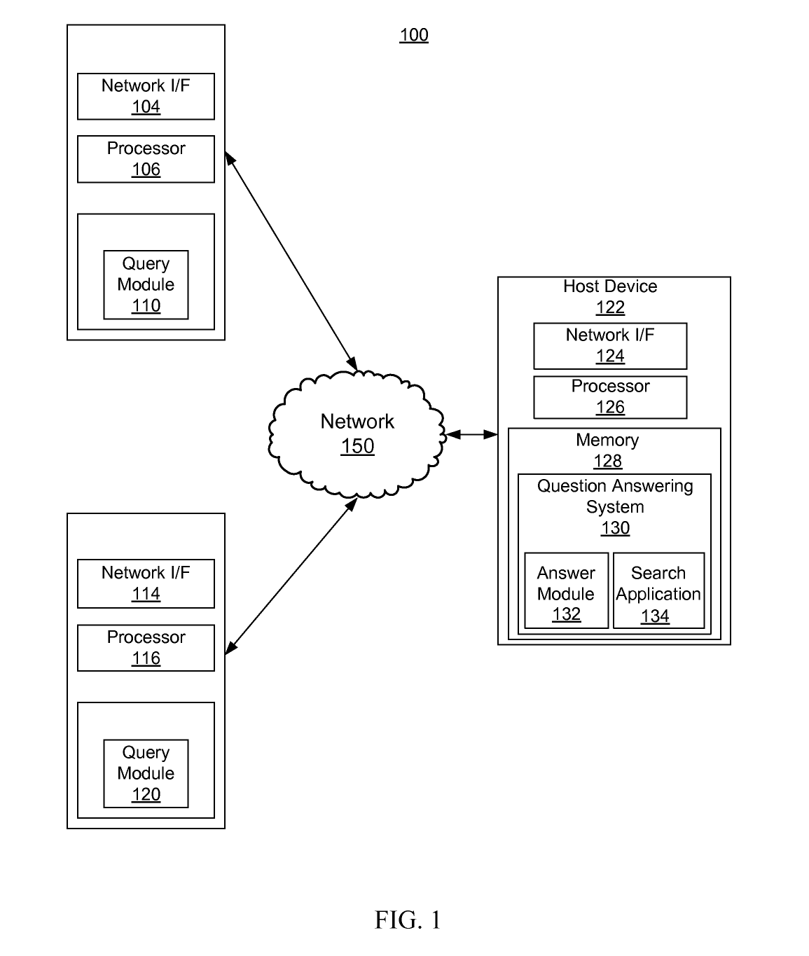

Turning now to the figures, FIG. 1 is a diagrammatic illustration of an exemplary computing environment, consistent with embodiments of the present disclosure. In certain embodiments, the environment 100 can include one or more remote devices 102, 112 and one or more host devices 122. Remote devices 102, 112 and host device 122 may be distant from each other and communicate over a network 150 in which the host device 122 comprises a central hub from which remote devices 102, 112 can establish a communication connection. Alternatively, the host device and remote devices may be configured in any other suitable relationship (e.g., in a peer-to-peer or other relationship).

In certain embodiments the network 100 can be implemented by any number of any suitable communications media (e.g., wide area network (WAN), local area network (LAN), Internet, Intranet, etc.). Alternatively, remote devices 102, 112 and host devices 122 may be local to each other, and communicate via any appropriate local communication medium (e.g., local area network (LAN), hardwire, wireless link, Intranet, etc.). In certain embodiments, the network 100 can be implemented within a cloud computing environment, or using one or more cloud computing services. Consistent with various embodiments, a cloud computing environment can include a network-based, distributed data processing system that provides one or more cloud computing services. In certain embodiments, a cloud computing environment can include many computers, hundreds or thousands of them, disposed within one or more data centers and configured to share resources over the network.

In certain embodiments, host device 122 can include a question answering system 130 (also referred to herein as a QA system) having a search application 134 and an answer module 132. In certain embodiments, the search application may be implemented by a conventional or other search engine, and may be distributed across multiple computer systems. The search application 134 can be configured to search one or more databases or other computer systems for content that is related to a question input by a user at a remote device 102, 112.

In certain embodiments, remote devices 102, 112 enable users to submit questions (e.g., search requests or other queries) to host devices 122 to retrieve search results. For example, the remote devices 102, 112 may include a query module 110 (e.g., in the form of a web browser or any other suitable software module) and present a graphical user (e.g., GUI, etc.) or other interface (e.g., command line prompts, menu screens, etc.) to solicit queries from users for submission to one or more host devices 122 and further to display answers/results obtained from the host devices 122 in relation to such queries.

Consistent with various embodiments, host device 122 and remote devices 102, 112 may be computer systems preferably equipped with a display or monitor. In certain embodiments, the computer systems may include at least one processor 106, 116, 126 memories 108, 118, 128 and/or internal or external network interface or communications devices 104, 114, 124 (e.g., modem, network cards, etc.), optional input devices (e.g., a keyboard, mouse, or other input device), and any commercially available and custom software (e.g., browser software, communications software, server software, natural language processing software, search engine and/or web crawling software, filter modules for filtering content based upon predefined criteria, etc.). In certain embodiments, the computer systems may include server, desktop, laptop, and hand-held devices. The computer systems may run Watson™ and formulate answers, calculate confidence scores, and poll users for their ratings. In addition, the answer module 132 may include one or more modules or units to perform the various functions of present disclosure embodiments described below (e.g., receiving questions, determining confidence scores for answers to questions, storing the questions and answers), and may be implemented by any combination of any quantity of software and/or hardware modules or units.

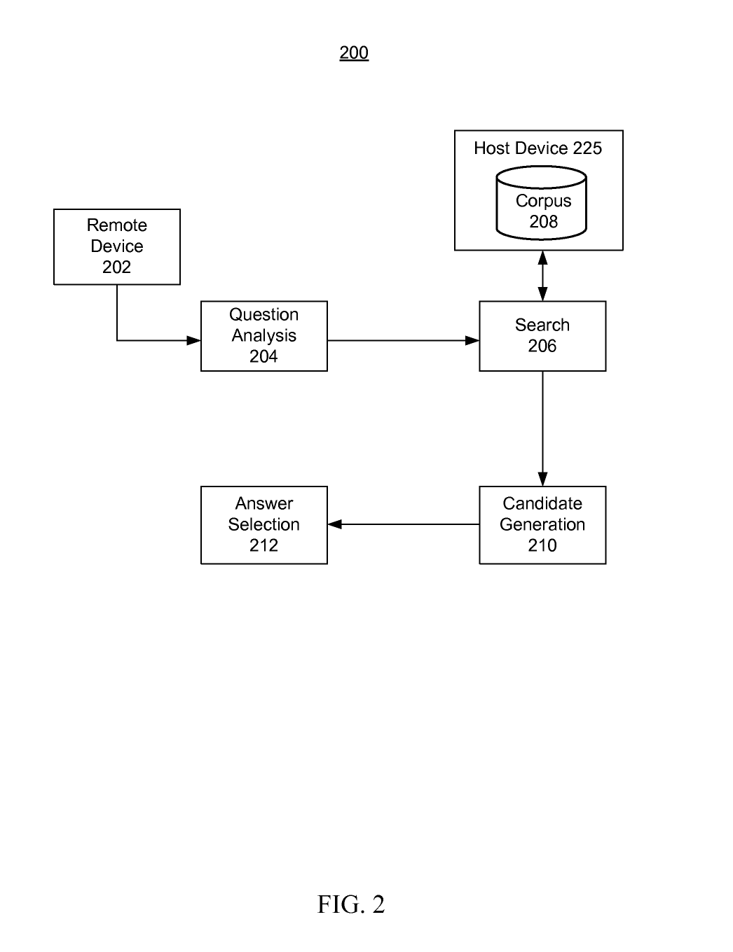

FIG. 2 is a system diagram depicting a high level logical architecture for a question answering system (also referred to herein as a QA system), consistent with embodiments of the present disclosure. Aspects of FIG. 2 are directed toward components for use with a QA system. In certain embodiments, the question analysis component 204 can receive a natural language question from a remote device 202, and can analyze the question to produce, minimally, the semantic type of the expected answer. The search component 206 can formulate queries from the output of the question analysis component 204 and may consult various resources such as the internet or one or more knowledge resources, e.g., databases, corpora 208, to retrieve documents, passages, web-pages, database tuples, etc., that are relevant to answering the question. For example, as shown in FIG. 2, in certain embodiments, the search component 206 can consult a corpus of information 208 on a host device 225. The candidate answer generation component 210 can then extract from the search results potential (candidate) answers to the question, which can then be scored and ranked by the answer selection component 212.

The various components of the exemplary high level logical architecture for a QA system described above may be used to implement various aspects of the present disclosure. For example, the question analysis component 204 could, in certain embodiments, be used to receive questions. Further, the search component 206 can, in certain embodiments, be used to perform a search of a corpus of information 208 in response to receiving the questions. The candidate generation component 210 can be used to determine confidence scores for answers to questions. Further, the answer selection component 212 can, in certain embodiments, be used to store the questions and answers.

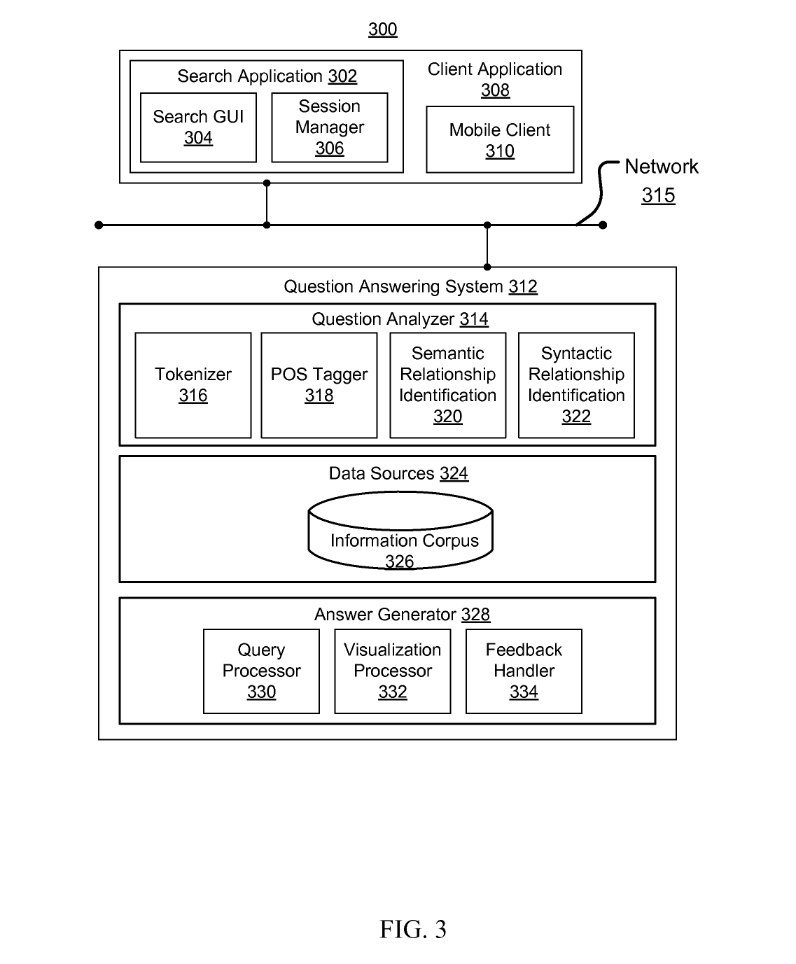

FIG. 3 is a block diagram illustrating a question answering system (also referred to herein as a QA system) to generate answers to one or more input questions, consistent with various embodiments of the present disclosure. Aspects of FIG. 3 are directed toward an exemplary system architecture 300 of a question answering system 312 to generate answers to queries (e.g., input questions). In certain embodiments, one or more users may send requests for information to QA system 312 using a remote device (such as remote devices 102, 112 of FIG. 1). QA system 312 can perform methods and techniques for responding to the requests sent by one or more client applications 308. Client applications 308 may involve one or more entities operable to generate events dispatched to QA system 312 via network 315. In certain embodiments, the events received at QA system 312 may correspond to input questions received from users, where the input questions may be expressed in a free form and in natural language.

A question (similarly referred to herein as a query) may be one or more words that form a search term or request for data, information or knowledge. A question may be expressed in the form of one or more keywords. Questions may include various selection criteria and search terms. A question may be composed of complex linguistic features, not only keywords. However, keyword-based search for answer is also possible. In certain embodiments, using unrestricted syntax for questions posed by users is enabled. The use of restricted syntax results in a variety of alternative expressions for users to better state their needs.

Consistent with various embodiments, client applications 308 can include one or more components such as a search application 302 and a mobile client 310. Client applications 308 can operate on a variety of devices. Such devices include, but are not limited to, mobile and handheld devices, such as laptops, mobile phones, personal or enterprise digital assistants, and the like; personal computers, servers, or other computer systems that access the services and functionality provided by QA system 312. For example, mobile client 310 may be an application installed on a mobile or other handheld device. In certain embodiments, mobile client 310 may dispatch query requests to QA system 312.

Consistent with various embodiments, search application 302 can dispatch requests for information to QA system 312. In certain embodiments, search application 302 can be a client application to QA system 312. In certain embodiments, search application 302 can send requests for answers to QA system 312. Search application 302 may be installed on a personal computer, a server or other computer system. In certain embodiments, search application 302 can include a search graphical user interface (GUI) 304 and session manager 306. Users may enter questions in search GUI 304. In certain embodiments, search GUI 304 may be a search box or other GUI component, the content of which represents a question to be submitted to QA system 312. Users may authenticate to QA system 312 via session manager 306. In certain embodiments, session manager 306 keeps track of user activity across sessions of interaction with the QA system 312. Session manager 306 may keep track of what questions are submitted within the lifecycle of a session of a user. For example, session manager 306 may retain a succession of questions posed by a user during a session. In certain embodiments, answers produced by QA system 312 in response to questions posed throughout the course of a user session may also be retained. Information for sessions managed by session manager 306 may be shared between computer systems and devices.

In certain embodiments, client applications 308 and QA system 312 can be communicatively coupled through network 315, e.g. the Internet, intranet, or other public or private computer network. In certain embodiments, QA system 312 and client applications 308 may communicate by using Hypertext Transfer Protocol (HTTP) or Representational State Transfer (REST) calls. In certain embodiments, QA system 312 may reside on a server node. Client applications 308 may establish server-client communication with QA system 312 or vice versa. In certain embodiments, the network 315 can be implemented within a cloud computing environment, or using one or more cloud computing services. Consistent with various embodiments, a cloud computing environment can include a network-based, distributed data processing system that provides one or more cloud computing services.

Consistent with various embodiments, QA system 312 may respond to the requests for information sent by client applications 308, e.g., posed questions by users. QA system 312 can generate answers to the received questions. In certain embodiments, QA system 312 may include a question analyzer 314, data sources 324, and answer generator 328. Question analyzer 314 can be a computer module that analyzes the received questions. In certain embodiments, question analyzer 314 can perform various methods and techniques for analyzing the questions semantically and syntactically. As is known to those skilled in the art, syntactic analysis relates to the study of a passage or document or according to the rules of a syntax. Syntax is the way (e.g., patterns, arrangements) in which linguistic elements (e.g., words, morphemes) are put together to form natural language components (e.g., phrases, clauses, sentences). In certain embodiments, question analyzer 314 can parse received questions. Question analyzer 314 may include various modules to perform analyses of received questions. For example, computer modules that question analyzer 314 may encompass include, but are not limited to a tokenizer 316, part-of-speech (POS) tagger 318, semantic relationship identification 320, and syntactic relationship identification 322.

Consistent with various embodiments, tokenizer 316 may be a computer module that performs lexical analysis. Tokenizer 316 can convert a sequence of characters into a sequence of tokens. Tokens may be string of characters typed by a user and categorized as a meaningful symbol. Further, in certain embodiments, tokenizer 316 can identify word boundaries in an input question and break the question or any text into its component parts such as words, multiword tokens, numbers, and punctuation marks. In certain embodiments, tokenizer 316 can receive a string of characters, identify the lexemes in the string, and categorize them into tokens.

Consistent with various embodiments, POS tagger 318 can be a computer module that marks up a word in a text to correspond to a particular part of speech. POS tagger 318 can read a question or other text in natural language and assign a part of speech to each word or other token. POS tagger 318 can determine the part of speech to which a word corresponds based on the definition of the word and the context of the word. The context of a word may be based on its relationship with adjacent and related words in a phrase, sentence, question, or paragraph. In certain embodiments, context of a word may be dependent on one or more previously posed questions. Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In certain embodiments, POS tagger 316 can tag or otherwise annotates tokens of a question with part of speech categories. In certain embodiments, POS tagger 316 can tag tokens or words of a question to be parsed by QA system 312.

Consistent with various embodiments, semantic relationship identification 320 may be a computer module that can identify semantic relationships of recognized entities in questions posed by users. In certain embodiments, semantic relationship identification 320 may determine functional dependencies between entities, the dimension associated to a member, and other semantic relationships.

Consistent with various embodiments, syntactic relationship identification 322 may be a computer module that can identify syntactic relationships in a question composed of tokens posed by users to QA system 312. Syntactic relationship identification 322 can determine the grammatical structure of sentences, for example, which groups of words are associated as “phrases” and which word is the subject or object of a verb. In certain embodiments, syntactic relationship identification 322 can conform to a formal grammar.

In certain embodiments, question analyzer 314 may be a computer module that can parse a received query and generate a corresponding data structure of the query. For example, in response to receiving a question at QA system 312, question analyzer 314 can output the parsed question as a data structure. In certain embodiments, the parsed question may be represented in the form of a parse tree or other graph structure. To generate the parsed question, question analyzer 130 may trigger computer modules 132-144. Question analyzer 130 can use functionality provided by computer modules 316-322 individually or in combination. Additionally, in certain embodiments, question analyzer 130 may use external computer systems for dedicated tasks that are part of the question parsing process.

Consistent with various embodiments, the output of question analyzer 314 can be used by QA system 312 to perform a search of one or more data sources 324 to retrieve information to answer a question posed by a user. In certain embodiments, data sources 324 may include data warehouses, information corpora, data models, and document repositories. In certain embodiments, the data source 324 can be an information corpus 326. The information corpus 326 can enable data storage and retrieval. In certain embodiments, the information corpus 326 may be a storage mechanism that houses a standardized, consistent, clean and integrated form of data. The data may be sourced from various operational systems. Data stored in the information corpus 326 may be structured in a way to specifically address reporting and analytic requirements. In one embodiment, the information corpus may be a relational database. In some example embodiments, data sources 324 may include one or more document repositories.

In certain embodiments, answer generator 328 may be a computer module that generates answers to posed questions. Examples of answers generated by answer generator 328 may include, but are not limited to, answers in the form of natural language sentences; reports, charts, or other analytic representation; raw data; web pages, and the like.

Consistent with various embodiments, answer generator 328 may include query processor 330, visualization processor 332 and feedback handler 334. When information in a data source 324 matching a parsed question is located, a technical query associated with the pattern can be executed by query processor 330. Based on retrieved data by a technical query executed by query processor 330, visualization processor 332 can render visualization of the retrieved data, where the visualization represents the answer. In certain embodiments, visualization processor 332 may render various analytics to represent the answer including, but not limited to, images, charts, tables, dashboards, maps, and the like. In certain embodiments, visualization processor 332 can present the answer to the user in understandable form.

In certain embodiments, feedback handler 334 can be a computer module that processes feedback from users on answers generated by answer generator 328. In certain embodiments, users may be engaged in dialog with the QA system 312 to evaluate the relevance of received answers. Answer generator 328 may produce a list of answers corresponding to a question submitted by a user. The user may rank each answer according to its relevance to the question. In certain embodiments, the feedback of users on generated answers may be used for future question answering sessions.

The various components of the exemplary question answering system described above may be used to implement various aspects of the present disclosure. For example, the client application 308 could be used to receive questions. The answer generator 328 can be used to determine confidence scores for answers to questions. The data sources 324 could, in certain embodiments, be used to store the questions and answers.

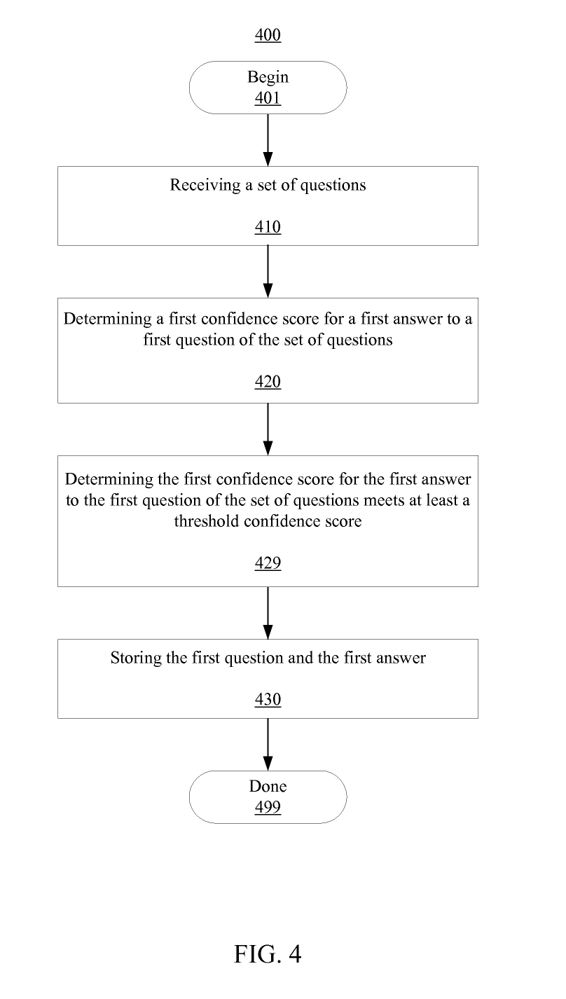

FIG. 4 is a flowchart illustrating a method 400 of managing data for a question and answering system according to embodiments. Aspects can facilitate transforming a conversation/dialogue into a question (e.g., based on meaning and not simply keywords). The method 400 begins at block 401. At block 410, a set of questions (one or more) is received by the QA system (e.g., from a user). For example, receiving could include collecting a transmission of a set of data or packets (at least one, one or more). Alternatively, receiving could include subscription to a publication of a set of data or packets. Receiving may be within the QA system by a first module from a second module. In embodiments, a plurality of the operations defined herein (including receiving) could occur within one module.

At block 420, a first confidence score for a first answer to a first question of the set of questions is determined. Confidence scores such as the first confidence score may be based on analytics that analyze evidence from a variety of dimensions. In embodiments, the first answer may be scored independent of evidence by deeper analysis algorithms (e.g., typing algorithms resulting in a lexical answer type). Algorithms may use different resources and techniques to come up with the first score. For instance, what is the likelihood that “Washington” for example, refers to a “General” or a “Capital” or a “State” or a “Mountain” or a “Father” or a “Founder”? A number of pieces of evidence can be subjected to various algorithms that deeply analyze evidentiary passages and score the likelihood that the passage supports or refutes the correctness of a particular answer. Such algorithms may consider variations in grammatical structure, word usage, and meaning (e.g., semantic/syntactic relationships). The particular answer can be paired with many pieces of evidence and scored by many algorithms. Such scoring may produce a grouping of evidentiary dimension scores which provide at least some evidence for the correctness of the particular answer. Trained models can be applied to weigh the relative importance of specific dimensions. Such models may be trained to predict (e.g., based on past performance) how best to combine the dimensions to produce confidence scores such as the first confidence score.

At block 429, a determination is made that the first confidence score meets a threshold confidence score (e.g., the first confidence score of 81 exceeds the threshold confidence score of 80). In certain environments, resources can be used efficiently by storing only those confidence scores exceeding the threshold. For example, certain users of the QA system may be willing to use an environment with a different threshold confidence score than other users. For example, a physician diagnosing a serious illness may use a super-computer environment with confidence scores exceeding a threshold of 50 while an adult with a slight cough may use a lean mobile-friendly environment exceeding a threshold of 90. In embodiments, the threshold confidence score may be user-selected. In embodiments, the threshold confidence score can be computed using an algorithm which takes into account user-ratings for specific answers (e.g., a more highly rated lot of answers with high confidence scores may have a higher threshold confidence score).

At block 430, the QA system stores the first question and the first answer. Storing the first question and the first answer may occur in response to the first confidence score meeting the threshold confidence score. Storage may occur in volatile memory or a cache. Storage may be configured for future use. In embodiments, future use may occur in substantially real-time (e.g., streaming applications). A database or multi-dimensional array, for example, may be used to store questions, answers, confidence scores, etc. In embodiments, storage may be configured for a cloud system that stores the first question and the first answer on a same storage node for efficiency in retrieval together. In other embodiments, storage may be configured for a cloud system that stores the first question and the first answer on different storage nodes (e.g., for instances when the questions and answers can be retrieved at different temporal periods). The method 400 concludes at block 499. Aspects of the method 400 may have a positive impact on search results, storage of questions/answers, organization of questions/answers, output of the QA system, or various performance efficiencies.

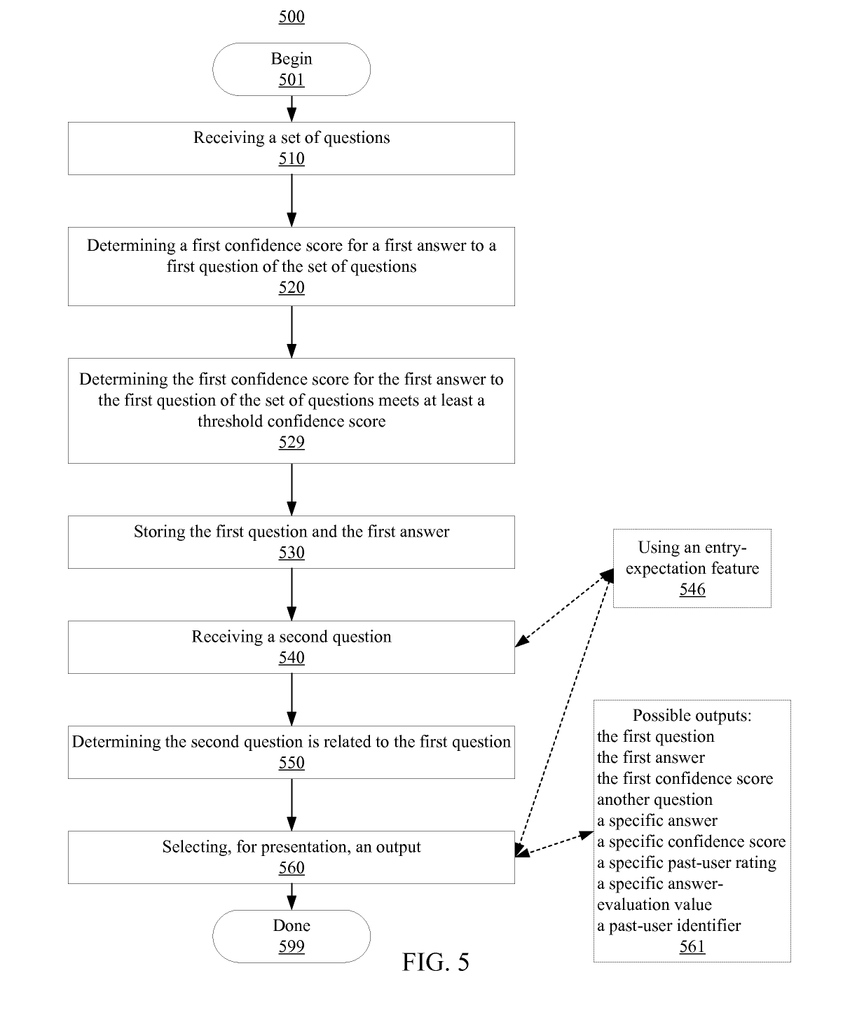

FIG. 5 is a flowchart illustrating a method 500 of managing data for a question and answering system according to embodiments. Aspects of method 500 may be similar to or the same as aspects of method 400. The method 500 begins at block 501. At block 510, a set of questions is received by the QA system. At block 520, a first confidence score for a first answer to a first question of the set of questions is determined. At block 529, a determination is made that the first confidence score meets a threshold confidence score. At block 530, the QA system stores the first question and the first answer.

At block 540, a second question is received (e.g., received from a user). In embodiments, an entry-expectation feature 546 (e.g., type-ahead feature) may be used to receive the second question from the user. The entry-expectation feature may present options for frequency and regarding which users have asked such questions historically. In embodiments, the user is a same user as in the first question (e.g., follow-up question). In embodiments, the user is a similar user as in the first question (e.g., two different call center service representatives working in a same office space supporting a same/similar item/product). In embodiments, the user is a distinctly different user as in the first question (e.g., different countries, different time zones, significantly different ages, different languages). In embodiments, the second question is received in response to receiving the first question (e.g., before storage of the first question/answer). In embodiments, the second question is received in response to storing the first question or storing the first answer (e.g., the first question/answer is stored and subsequently the second question is received).

At block 550, it can be determined that the second question is related to the first question. Determination of a relationship between the first and second questions may include a comparison. In embodiments, a natural language processing technique (e.g., using a software tool or widget) may be used to analyze the questions to determine the relationship. In particular, the natural language processing technique can be configured to parse a semantic feature and a syntactic feature of the questions. For example, syntactic and semantic relationships may be evaluated to recognize keywords, contextual information, and metadata tags associated with the questions. Specifically, keywords or phrases can be utilized to compare the first and second questions. Similar items/aspects may be determined to match/mismatch one another. For example, in certain contexts, a first smartphone may match a second smartphone (e.g., “volume button location” on an “ACME series 1” versus an “ACME series 2”). However, in other contexts, the first smartphone may mismatch the second smartphone (e.g., “how to record video” using the “ACME series 1” versus the “ACME series 2”).

In certain embodiments, the natural language processing technique can be configured to analyze summary information, keywords, figure captions, and text descriptions included in the questions, and use syntactic and semantic elements present in this information to determine the relationship. The syntactic and semantic elements can include information such as word frequency, word meanings, text font, italics, hyperlinks, proper names, noun phrases, parts-of-speech, and the context of surrounding words. Other syntactic and semantic elements are also possible. Based on the analyzed metadata, contextual information, syntactic and semantic elements, and other data, the natural language processing technique can be configured to determine the relationship.

At block 560, an output can be selected for presentation (e.g., displayed to the user). The output may be textual, audio, or visual (e.g., still image, video) and can include frequency/user information. User interface rendering can show the user a variety of information to set user-expectations regarding the output. An entry-expectation feature 546 (e.g., type-ahead feature) may be used to present to the user the output. As such, a suggestion may be made to the user for the user to select a particular output (e.g., particular question) that the QA system has a quality answer to (e.g., based on answer-evaluation value, confidence score, user-rating).

In embodiments, the output can include various possible aspects as described at block 561. The output may include the first question (e.g., “number of Washington's in the USA”). The output may include the first answer (e.g., “thirty counties and one parish plus cities and parks”). The output may include the first confidence score (e.g., “34 out of 100”). The output may include another question (e.g., “did you mean the number of U.S. cities having Washington in the city name?”) such as a variant of the question (e.g., “number of people named Washington in the USA). The output may include a specific answer (e.g., “four Fort Washington's exist in the USA”). The output may include a specific confidence score (e.g., “D-grade”). The output may include a specific past-user rating (e.g., “3 out of 10”). The output may include an answer-evaluation value (e.g., “4 out of 100). The output may include a past-user identifier (e.g., “Internet Protocol Address x.xyz.yz.zzz, located in Washington, Iowa”). Combinations of such output examples may be utilized in delivering the selected output along with other features. In embodiments, the output selects questions to present the user based on answer evaluation values of the set of questions (e.g., chooses the better questions for presentation from a plurality of thematically related questions). The method 500 concludes at block 599. Aspects of method 500 can produce both result-oriented and performance-oriented efficiencies.

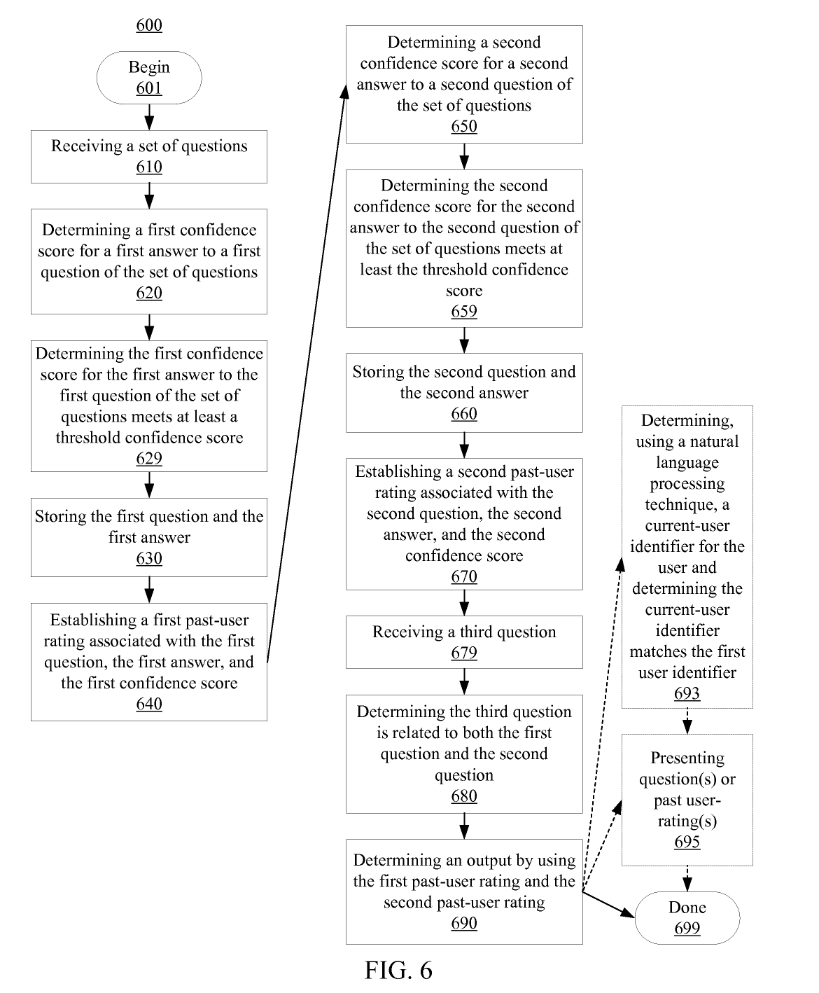

FIG. 6 is a flowchart illustrating a method 600 of managing data for a question and answering system according to embodiments. Aspects of method 600 may be similar to or the same as aspects of methods 400 or 500. The method 600 begins at block 601. At block 610, a set of questions is received by the QA system. At block 620, a first confidence score for a first answer to a first question of the set of questions is determined. At block 629, a determination is made that the first confidence score meets a threshold confidence score. At block 630, the QA system stores the first question and the first answer.

At block 640, a first past-user rating may be established. The first past-user rating can be associated with the first question, the first answer, and the first confidence score. In embodiments, the first past-user rating, the first question, the first answer, and the first confidence score are stored in a database or multi-dimensional array. The first past-user rating may include how a historical/past/previous user rated a specific feature (e.g., one or more aspects such as question, answer, or confidence score) of what was returned to the historical user (e.g., a descriptive/numerical manner of how the historical user rated the answer provided by the QA system such as by letter-grade, percentage-grade, star-rating, thumbs-up/down, or 0/1). The past-user rating may include incrementing or decrementing a count. The count may be used to generate statistical indicators such as averages, variances, deviations, norms, charts, graphs, etc.

At block 650, a second confidence score for a second answer to a second question of the set of questions may be determined. The second confidence score may be determined in response to receiving the set of questions (e.g., in response to receiving the second question). In response to determining the second confidence score meets the threshold confidence score at block 659, the QA system may store the second question and the second answer at block 660. At block 670, a second past-user rating may be established. The second past-user rating can be associated/linked with the second question, the second answer, and the second confidence score.

At block 679, a third question may be received (e.g., received from a user). In response to receiving the third question, at block 680 it can be determined that the third question is related to both the first question and the second question. Such determination can be made using natural language processing techniques (see e.g., FIG. 5 block 550 above). In response to determining the third question is related to both the first question and the second question, an output may be determined at block 690. Determining the output can use the first and second past-user ratings.

In various embodiments, a current-user identifier for the user may be determined using a natural language processing technique of the QA system at block 693. As such, the current-user identifier may match the first user identifier (e.g., same user). Accordingly, the first past-user rating can be presented in response to a first past-user identifier of the first past-user rating differing from a second past-user identifier of the second past-user rating. Identifying information that the same user is utilizing the QA system may have benefits in returning a result satisfactory to that same user. Also, a particular past-user rating can be presented for context to an existing/future user. Information related to knowledge/skills/abilities of users (both past and present) can assist in reaching satisfactory results efficiently.

In embodiments, at block 695 the first question is presented to the user in response to the first past-user rating exceeding the second past-user rating (e.g., presenting/displaying a first previously asked question deemed more helpful/appropriate/satisfactory by users than a second previously asked question). In embodiments when the first past-user rating is substantially equivalent to the second past-user rating, the second question is presented to the user in response to the second confidence score exceeding the first confidence score (e.g., displaying the previous asked question deemed more confidently accurate/precise/truthful by the QA system when user-ratings are within a margin of error such as 5% or 10%). The method 600 concludes at block 699. Aspects of the method 600 may have a positive impact on search results, storage of questions/answers, organization of questions/answers, output of the QA system, or various performance efficiencies.

Consider the illustrative example that follows. A storage system may be used to store a database of questions asked of the QA system and the confidence of answers provided by the QA system. Feedback (e.g., regarding relevancy) of particular answers may be accounted for based on user-ratings provided by the users of the QA system for the particular answers. As such, the QA system can generate a list of questions that it has quality answers to (e.g., above a threshold level of quality). In embodiments, when a user starts to type a question into an input text field of a user interface, the user can be presented with a type-ahead of possible questions (e.g., likely questions with quality answers). Accordingly, the QA system may operate efficiently without asking a significant number of follow-up questions to generate a complete question.

As customer service representatives (CSRs) in contact centers may be asked the same question on a daily basis, the QA system may be asked the same question repeatedly. The QA system can give vastly different results based on the way the question is asked. Aspects of the disclosure guide the users of the system to more complete questions that the QA system can produce better answers for. If a CSR started to type ACME smartphone 5, the QA system can provide a list of questions such as “How to charge an ACME smartphone 5 with a PC” or “How to charge an ACME smartphone 5 with a wall charger” in addition to correlating answer confidence scores/values. Providing the list may produce desirable performance or efficiency benefits (e.g., to generate a complete question).

For instance, imagine an example dialogue (e.g., sequence of related questions/answers) in the contact center as follows. CSR: How to charge an ACME smartphone. QA system: What model of ACME smartphone? CSR: ACME smartphone 5. QA system: What power source are you using? CSR: Wall Charger QA system: Answer. If the QA system can provide a list of commonly asked question with identifiably good answers, such as “How to charge an ACME smartphone 5 with a wall charger”, the CSR could have made that selection. That selection could reduce the system load by not having to provide follow-up questions, providing a faster response to customer-users, and learning (e.g., via machine learning) a question style that returns highly confident results.

The general methodology of how the QA system builds a repository of questions, confidences, and user-ratings includes a plurality of operations as applied to the example. The CSR asks the QA system a question. The QA system stores the question along with a confidence score and returns the answer with the confidence score. The CSR provides feedback. The QA system updates the question using the user feedback. In specific embodiments of the example, if that was only question asked of the system, and the CSR began to type “ACME smartphone” in the question input field, the CSR could be presented on the display with the question “How to share a photo stream on ACME smartphone 5” along with its confidence and rating scores.

Aspects of the disclosure include grouping semantically similar questions. For instance, the QA system can recognize that “Using a Wall Charger, how I can charge an ACME smartphone 4” and “How to charge and ACME smartphone 4 with a Wall Charger” are the same question. However, the context of the question can affect the results from the QA system. Thus, higher confidence and higher user-rated outputs will be provided in a type-ahead area. Similarly, if a user typed in “How to take a picture using . . . ”, Watson would recognize that ‘taking a picture’ is related to ‘photography’ and that the question may relate to multiple devices/platforms.

Returning to the example dialogue above, the example dialogue could be transformed into a new question “How to charge an ACME smartphone 5 with a Wall Charger?” The new question may be stored along with a confidence score of a final answer and a user-rating. That result may be grouped with other similar questions and displayed in the type-ahead area. A table may result as follows:

TABLE 1

| ID | Question | Confidence | Rating |
|---|---|---|---|
| 1 | How to share a photo stream on ACME | 87% | 100% |
| | smartphone 5 | | |
| 2 | On an ACME smartphone 5, how can I share | 85% | 100% |
| | a photo stream | | |
| 3 | How to charge an ACME smartphone 5 | 90% | 90% |
| | using a PC | | |
| 4 | Using PC/USB cable, how do you charge | 85% | 100% |
| | an ACME smartphone 5 | | |
| 5 | How can I take a photo using an ACME | 98% | 50% |
| | smartphone 4 | | |
| 6 | take photos using the front facing camera | 88% | 100% |
| | of an ACME smartphone 4 | | |

In an embodiment a type-ahead feature may provide three potential questions. The questions the QA system may present/display when a user enters “ACME smartphone” can be ID 6 (take photos using the front facing camera of an ACME smartphone 4), ID 1 (How to share a photo stream on ACME smartphone 5), and ID 4 (Using PC/USB cable, how do you charge an ACME smartphone 5). In further detail, ID 6 and ID 5 are not exactly the same question but may be considered similar. ID 6 has higher user rating for resolving calls even though ID 5 has a higher confidence. Next, ID 1 and ID 2 may be considered the same question. ID 1 has a higher confidence score when compared with ID 2 and their user-ratings are the same. Lastly, ID 4 and ID 3 may be considered the same question. ID 3 has higher confidence score, but lower user-rating. User-rating may be given a higher weight because the QA system may have a performance preference to resolve calls. ID 4 appears to be better at resolving calls, so ID 4 ranks higher. Because the user-ratings are identical for the three chosen questions, they can be ranked by confidence score of the QA system when displayed in the type-ahead area.

The questions the QA system may present/display when a user enters “picture” can include ID 6 because the QA system may identify that taking photos and pictures are related concepts. ID 1 may be presented/displayed because the QA system may identify that a photo stream and pictures are related concepts. ID 1 may rank lower if more “picture” and “image” related questions were in the table because “photo stream” may be considered different. ID 4 may be presented/displayed because: ID 4 and ID 6 may be related questions, but not the same question; the QA system may have exhausted highly-rated questions related to images and photos; and, ID 1 and ID 2 are the same question, while the QA system may be deterred both from presenting ID 2 and from presenting something related to charging a phone.

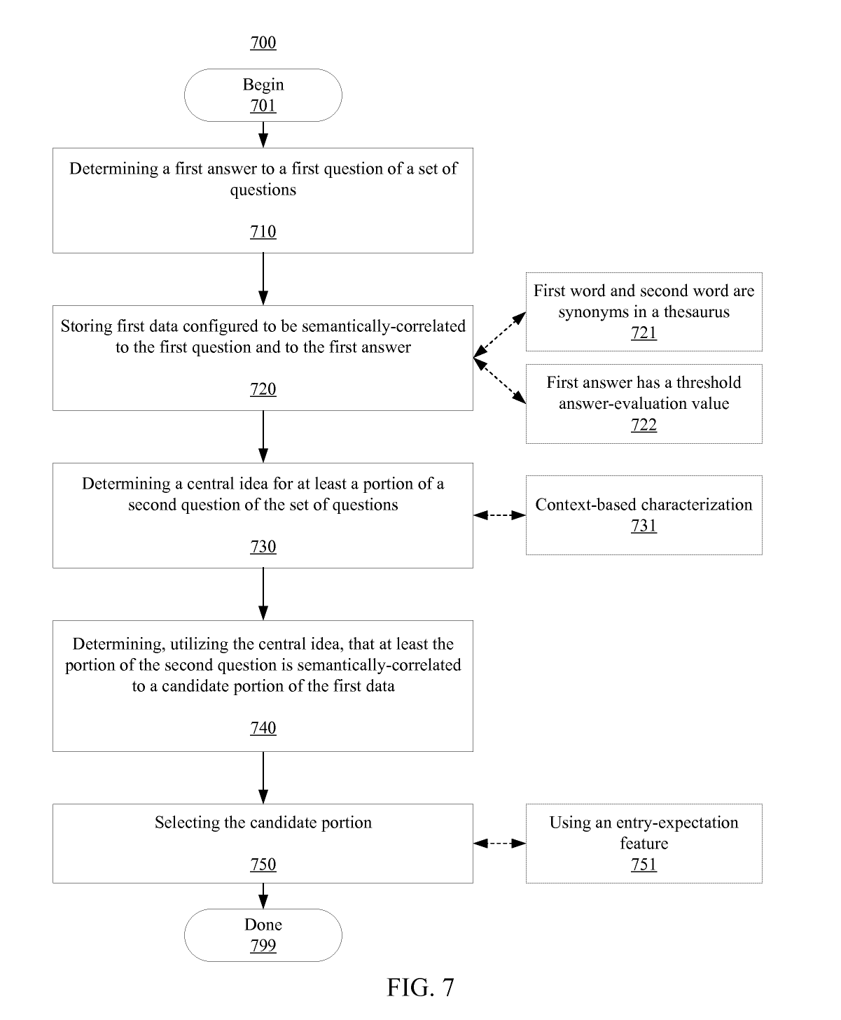

FIG. 7 is a flowchart illustrating a method 700 of using stored data by a question and answering system according to embodiments. Aspects of method 700 may provide an output/suggestion by analyzing the central idea of the question of the user and compare the central idea to the meaning of a previously stored question/answer. The method 700 begins at block 701.

At block 710, a first answer to a first question of a set of questions is determined. At block 720, first data configured to be semantically-correlated to the first question and to the first answer is stored. Semantically-correlated can include a first word being found as a synonym for a second word in a thesaurus at block 721. First data may include a syntax characteristic (phrasing) of the first answer determined to have at least a threshold answer-evaluation value at block 722. An answer-evaluation value may be based on at least one of a user-rating or a confidence score. In embodiments, the answer-evaluation value may use statistical methods to be computed using both the user-rating and the confidence score. The answer-evaluation value can include various measurement/calculation methodologies for performance, accuracy, precision, efficiency, timeliness, cost, or relational factors.

At block 730, a central idea for at least a portion of a second question of the set of questions may be determined. In embodiments, the central idea may include a context-based characterization, determined using a natural language processing technique of the QA system, of the second question at block 731. At block 740, method 700 determines, utilizing the central idea, that at least the portion of the second question is semantically-correlated to a candidate portion of the first data. At block 750, the candidate portion is selected. In embodiments, the candidate portion and at least one answer-evaluation value can be presented as an entry-expectation feature at block 751. The method 700 may conclude at block 799.

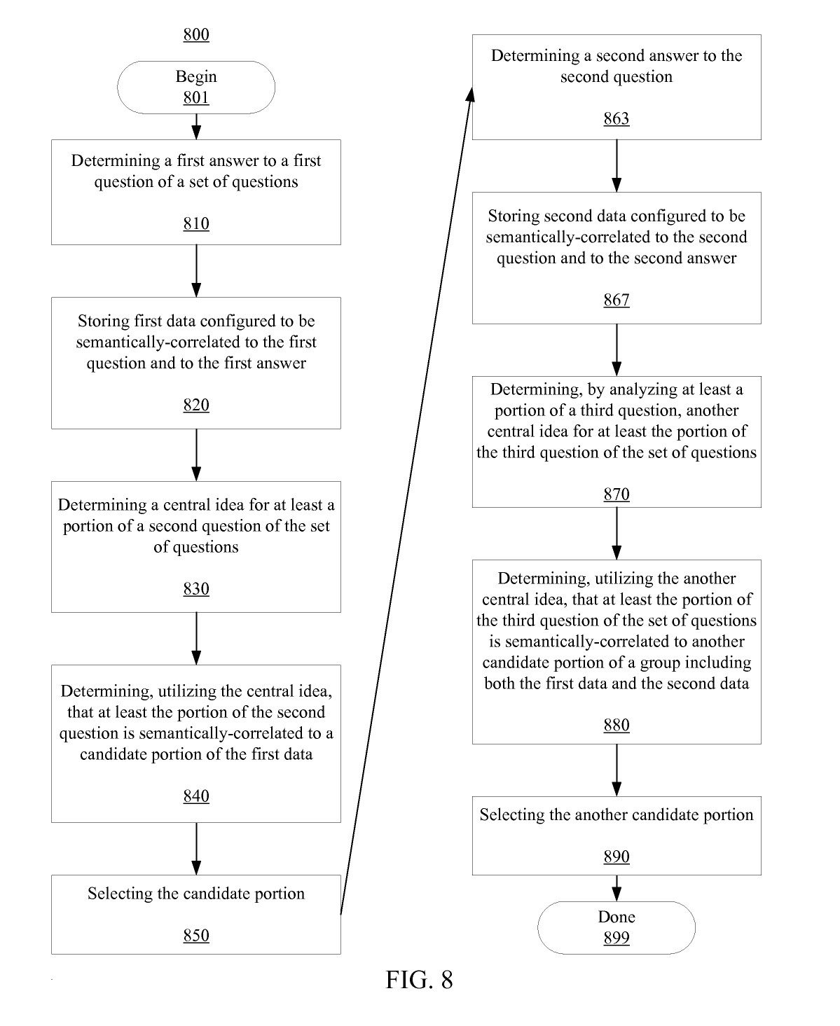

FIG. 8 is a flowchart illustrating a method 800 of using stored data by a question and answering system according to embodiments. Aspects of method 800 may be similar to or the same as aspects of method 700. The method 800 begins at block 801. At block 810, a first answer to a first question of a set of questions is determined. At block 820, first data configured to be semantically-correlated to the first question and to the first answer is stored. At block 830, a central idea for at least a portion of a second question of the set of questions may be determined. At block 840, method 800 determines, utilizing the central idea, that at least the portion of the second question is semantically-correlated to a candidate portion of the first data. At block 850, the candidate portion is selected.

At block 863, the QA system analyzes the second question of the set of questions (in response to receiving the second question) to determine a second answer to the second question. At block 867, second data is stored. The second data can be configured to be semantically-correlated to the second question of the set of questions and to the second answer to the second question. At block 870, by analyzing at least a portion of a third question of the set of questions in response to receiving at least the portion of the third question of the set of questions, another central idea may be determined for at least the portion of the third question of the set of questions. At block 880, by the QA system utilizing the another central idea for at least the portion of the third question of the set of questions, it can be determined that at least the portion of the third question of the set of questions is semantically-correlated to another candidate portion of a group including both the first data and the second data. At block 890, the QA system selects the another candidate portion. The method 800 may conclude at block 899.

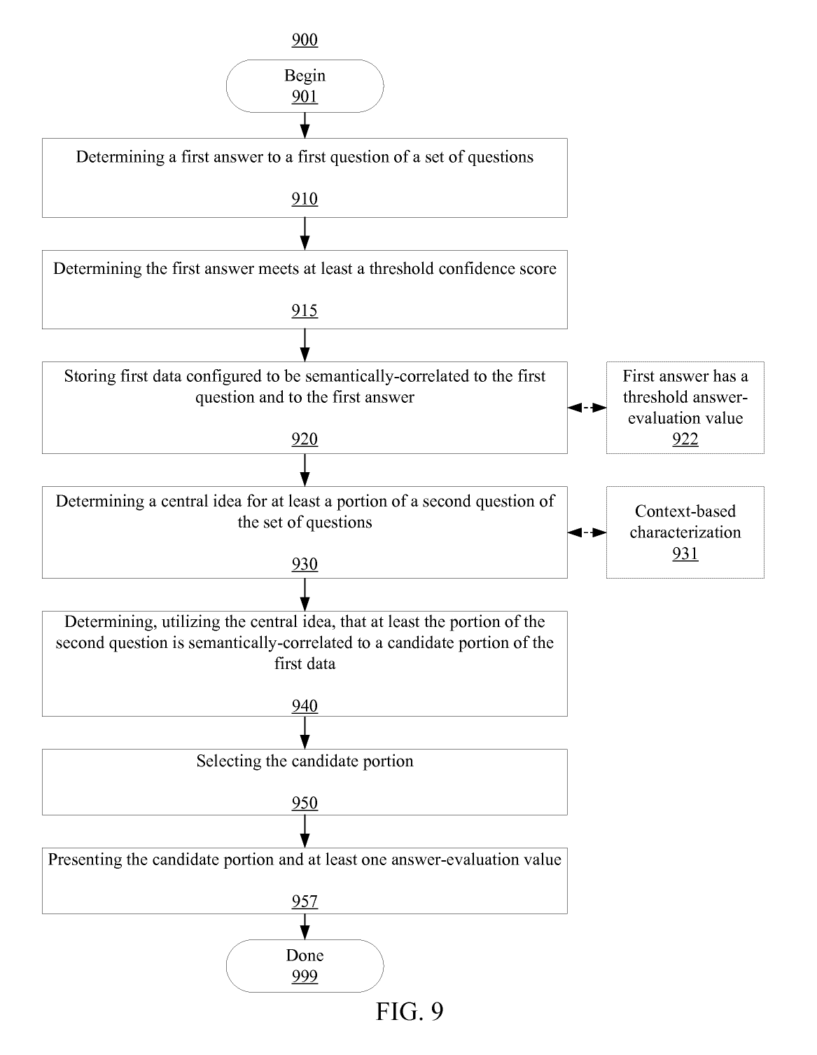

FIG. 9 is a flowchart illustrating a method 900 of using stored data by a question and answering system according to embodiments. Aspects of method 900 may be similar to or the same as aspects of methods 700 or 800. The method 900 begins at block 901. At block 910, a first answer to a first question of a set of questions is determined. At block 915, it is determined that the first answer meets at least a threshold confidence score. In response at block 920, first data configured to be semantically-correlated to the first question and to the first answer is stored. First data may include a phrasing of the first answer determined to have at least a threshold answer-evaluation value at block 922.

At block 930, a central idea for at least a portion of a second question of the set of questions may be determined. In embodiments, the central idea may include a context-based characterization, determined using a natural language processing technique of the QA system, of the second question at block 931. At block 940, method 900 determines, utilizing the central idea, that at least the portion of the second question is semantically-correlated to a candidate portion of the first data. At block 950, the candidate portion is selected. Selecting the candidate portion can include using an entry-expectation feature that utilizes a disambiguated element derived from the first data (e.g., to resolve uncertainty of meaning associated with the disambiguated element). At block 957, the candidate portion and at least one answer-evaluation value is presented. The method 900 may conclude at block 999. Aspects of the method 900 may have a positive impact on search results, storage of questions/answers, organization of questions/answers, output of the QA system, or various performance efficiencies.

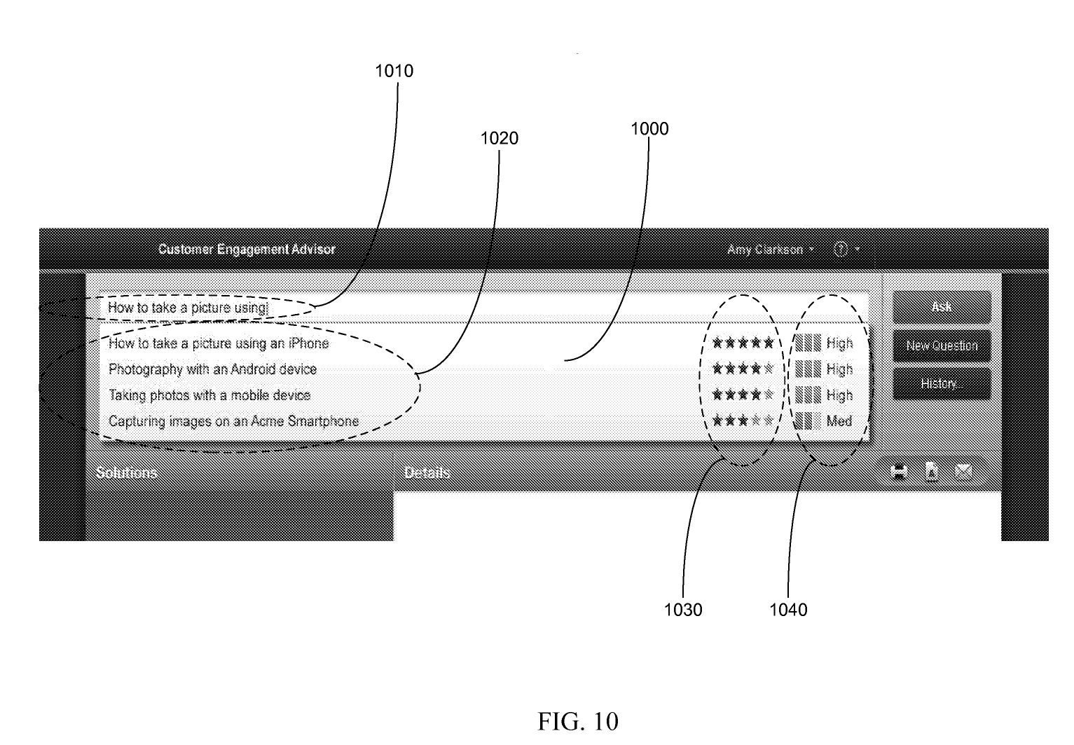

FIG. 10 is an illustration of a display of an exemplary computer using a question and answering system according to embodiments. The display may include an output 1000. Aspects of the display include an entry question 1010 being received by the QA system. A set of suggested questions 1020 may be displayed. The set of suggested questions 1020 may be in association with a set of past-user ratings 1030 for a set of answers to the suggested questions and a set of confidence scores 1040 for the set of answers to the suggested questions. The set of suggested questions 1020 may be sorted, organized, or otherwise presented according to methodologies described herein (e.g., presenting the set of suggested questions based on correlation to semantic features of the entry question using a prioritized sorting of the set of suggested questions by confidence score and then past-user rating while each suggested question of the set of suggestion questions meets a threshold confidence score or a threshold past-user rating).

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow.

What is claimed is:

1. A computer-implemented method of managing data for a Question and Answering (QA) system, the method comprising:
receiving, by the QA system, a set of questions;
determining, in response to receiving the set of questions, a first confidence score for a first answer to a first question of the set of questions;
storing, by the QA system in response to determining the first confidence score meets at least a threshold confidence score, the first question and the first answer;
receiving a second question from a user;
determining the second question is related to the first question; and
selecting, for presentation to the user, an output.

2. The method of claim 1, wherein the output is selected from a group consisting of at least one of: the first question, the first answer, the first confidence score, a group of questions, a group of answers, a group of confidence scores, a first past-user rating, an answer-evaluation value, or a past-user identifier.

3. The method of claim 2, further comprising using an entry-expectation feature to receive the second question from the user and to present to the user the output including both the first question and the answer-evaluation value.

4. The method of claim 1, further comprising establishing a first answer-evaluation value associated with the first question, the first answer, and the first confidence score.

5. The method of claim 4, further comprising:
determining, in response to receiving the set of questions, a second confidence score for a second answer to a second question of the set of questions;
storing, by the QA system in response to determining the second confidence score for the second answer to the second question of the set of questions meets at least the threshold confidence score, the second question and the second answer;
establishing a second answer-evaluation value associated with the second question, the second answer, and the second confidence score;
determining, in response to receiving a third question from a user, the third question is related to both the first question and the second question;
determining, in response to determining the third question is related to both the first question and the second question, an output by using the first answer-evaluation value and the second answer-evaluation value, wherein the output includes both the first question and the second question.

6. The method of claim 5, further comprising presenting the first question to the user in response to the first answer-evaluation value exceeding the second answer-evaluation value.

7. The method of claim 5, further comprising presenting, in response to the first answer-evaluation value being substantially equivalent to the second answer-evaluation value, the second question to the user in response to the second confidence score exceeding the first confidence score.

8. The method of claim 5, further comprising presenting the first answer-evaluation value.

9. The method of claim 1, further comprising:
determining, using a natural language processing technique of the QA system, a current-user identifier for the user; and
determining the current-user identifier matches a first past-user identifier.

10. The method of claim 1, further comprising:
determining the first answer to the first question of the set of questions;
storing first data configured to be semantically-correlated to the first question and to the first answer;
determining a first central idea for at least a portion of a second question of the set of questions;
determining, utilizing the first central idea, that at least the portion of the second question is semantically-correlated to a first candidate portion of the first data; and
selecting the first candidate portion.

11. The method of claim 10, further comprising:
determining, by the QA system analyzing the second question of the set of questions in response to receiving the second question, a second answer to the second question; and
storing second data, the second data configured to be semantically-correlated to the second question of the set of questions and to the second answer to the second question.

12. The method of claim 11, further comprising:
determining, by analyzing at least a portion of a third question of the set of questions in response to receiving at least the portion of the third question of the set of questions, a second central idea for at least the portion of the third question of the set of questions; and
determining, by the QA system utilizing the second central idea for at least the portion of the third question of the set of questions, that at least the portion of the third question of the set of questions is semantically-correlated to a second candidate portion of a group including both the first data and the second data; and
selecting, by the QA system, the second candidate portion.

13. The method of claim 10, wherein selecting the first candidate portion includes using an entry-expectation feature that utilizes a disambiguated element derived from the first data.

14. The method of claim 10, wherein the first central idea for at least the portion of the second question of the set of questions includes a context-based characterization, determined using a natural language processing technique of the QA system, of the second question.

15. The method of claim 10, wherein first data includes a syntax characteristic of the first answer determined to have at least a threshold answer-evaluation value.

16. The method of claim 10, further comprising presenting, using an entry-expectation feature, the first candidate portion and at least one answer-evaluation value.

17. The method of claim 10, wherein storing the first data occurs in response to determining the first answer meets at least a threshold confidence score.

18. The method of claim 1, further comprising:
receiving a third question from the user;
determining a third confidence score for a third answer to the third question;
storing, by the QA system in response to determining the third confidence score meets at least the threshold confidence score, the third question and the third answer;
receiving a fourth question from the user;
determining the fourth question is related to the third question; and
selecting, based on a group of answer-evaluation values for the set of questions, the output, wherein the output includes:
one of the first question and the second question, and
one of the third question and the fourth question.
